(19) United States
(12) Patent Application Publication
(10) Pub. No.: US 2010/0235318 A1
(43) Pub. Date: Sep. 16, 2010

(54) Terminal and Operation Confirmation Method

(75) Inventor: Rui WANG, Shenzhen (CN)

Correspondence Address: Huawei Technologies Co., Ltd., IPR Dept., Building B1-3-A,, Huawei Industrial Base, Bantian, Shenzhen Guangdong, 518129, CN

(73) Assignee: HUAWEI TECHNOLOGIES CO., LTD., Shenzhen (CN)

(21) Appl. No.: 12/788,554

(22) Filed: May 27, 2010

Related U.S. Application Data
(63) Continuation of application No. PCT/CN2008/073160, filed on Nov. 21, 2008.

(30) Foreign Application Priority Data
Nov. 27, 2007 (CN) 200710178176.6

(51) Int. Cl. G06F 15/00

(52) U.S. Cl. 706/62

(57) ABSTRACT

A terminal and an operation confirmation method are provided. The terminal includes an operation executing module and a decision judging module. The method includes an operation executing module operable to send an operation authorization request to the decision judging module, and a decision judging module operable to receive the operation authorization request, and obtain user authorization information according to the operation authorization request. The operation authorization response is sent to the operation executing module in response to the operation authorization request according to the user authorization information. In further embodiments, the method includes generating an operation authorization response according to user authorization information when an operation process comes to the step of seeking confirmation from the user.

### CROSS-REFERENCE TO RELATED APPLICATIONS

This application is a continuation of International Application No. PCT/CN2008/073160, filed on Nov. 21, 2008, which claims priority to Chinese Patent Application No. 200710178176.6, filed on Nov. 27, 2007, both of which are hereby incorporated by reference in their entireties.

### FIELD OF THE INVENTION

The present invention relates to radio communication, and in particular, to a terminal and an operation confirmation method.

### BACKGROUND OF THE INVENTION

With the development of radio communication applications, terminals are more and more indispensable to the daily life of people, and people impose higher and higher requirements on the look and feel of terminals. Service Providers (SPs) expect to provide the users with different styles of look-and-feel elements and look-and-feel packages, and enable the users to demonstrate their individualized look and feel of terminals. The SPs expect to manage the look-and-feel elements and the look-and-feel packages of the terminals through the network to benefit both the users and the SPs.

Terminal “look-and-feel” refer to the content displayed to the outside by a terminal, including wallpapers, ring tones, menus, and so on, which are known as “look-and-feel elements”. The set of such elements is called a “look-and-feel package” when multiple look-and-feel elements are provided to the terminal simultaneously or when the terminal operates the elements.

The operations performed by a server with respect to a terminal to manage the look-and-feel of the terminal include: delivering a look-and-feel package, installing, activating/deactivating, updating, deleting, and locking/unlocking “Delivering” refers to sending a look-and-feel package to the user; “installing” refers to installing the received look-and-feel package on the terminal and generating a series of new look-and-feel elements; “activating” refers to making a specific look-and-feel package effective on the terminal; “updating” refers to updating the existing look-and-feel package according to the contents in the received look-and-feel package; “deleting” refers to deleting a specific look-and-feel package stored on the terminal; “locking” refers to locking a look-and-feel package against modification, and “unlocking” refers to unlocking a locked look-and-feel package.

Taking the look-and-feel installation as an example, the look-and-feel management mode on a terminal is as follows: The user downloads a look-and-feel package from the website of an SP, and installs the downloaded package. In this case, the installation of the look-and-feel package is executed manually by the user, and two scenarios exist. The first scenario is as follows: It takes some time to download the look-and-feel package, but the user does not wait for completion of the downloading. When the terminal finishes downloading the look-and-feel package and needs to install the package, the installation is subject to confirmation of the user. If the user agrees to continue, the terminal continues the installation; otherwise, the terminal foregoes the installation. The second scenario is as follows: The user subscribes to a look-and-feel package on the Internet. When a new look-and-feel package is launched on the website of the SP, the website delivers the look-and-feel package to the user actively. However, the installation of the look-and-feel package is subject to confirmation of the user. If the user agrees, the installation of the look-and-feel package goes on; otherwise, the installation aborts. Other operations of managing look and feel, for example, updating, deleting, locking, and locking, are also subject to confirmation of the user.

In the prior art, the user may confirm whether to continue with the operation in many ways, but the essence is: A dialog box is displayed, requesting the user to input the authorization information; the user chooses whether to accept or reject the operation; and the terminal performs the operation according to the selection made by the user. Alternatively, the terminal searches the terminal settings for the authorization information of the user, and performs the corresponding operation according to the obtained authorization information of the user.

When one or more modes of obtaining the user authentication information need to be added, codes for judging obtained user authorization information need to be added, and the codes related to the executing program and the judging program need to be modified massively, thus affecting the stability, maintenance and extension of the codes and affecting the stability of the product quality. For example, on the basis of obtaining the user authorization information through a dialog box, the SP expects to add a mode of obtaining the user authorization information by querying the terminal settings. In this case, the SP has to add the codes about how to obtain the user authorization information by querying the terminal settings into the existing program of the terminal. This involves massive modification to the existing codes, affects the stability and maintenance of the codes, and affects the product quality.

### SUMMARY OF THE INVENTION

A terminal and an operation confirmation method are provided in embodiments of the present invention to improve product stability and to avoid massive modification of codes in the case of adding one or more modes of obtaining user authorization information. The embodiments of the present invention are implemented through the following technical solution:

A terminal provided in an embodiment of the present invention includes:

an operation executing module, adapted to send an operation authorization request; and

a decision judging module, adapted to: receive the operation authorization request, and obtain user authorization information according to the operation authorization request; send an operation authorization response to the operation executing module in response to the operation authorization request according to the user authorization information.

An operation confirmation method provided in an embodiment of the present invention includes:

receiving, such as by a decision judging module, an operation authorization request from an operation executing module; and

obtaining, such as by the decision judging module, user authorization information according to the operation authorization request, and sending an operation authorization response to the operation executing module in response to the operation authorization request according to the user authorization information.

The technical solution under the present invention affords at least the following benefits: When the SP needs to add a mode of obtaining user authorization information, the codes do not need to be modified massively, thus making it convenient to maintain and extend codes and improving the stability and reliability of the product.

### BRIEF DESCRIPTION OF THE DRAWINGS

FIG. 1 shows a structure of a terminal provided in a first embodiment of the present invention;

FIG. 2 shows a user interface provided in the first embodiment of the present invention; and

FIG. 3 shows a structure of a terminal provided in a second embodiment of the present invention.

### DETAILED DESCRIPTION OF THE EMBODIMENTS

The objectives and merits of the present invention are described in conjunction with preferred embodiments with reference to the accompanying drawings.

### Embodiment 1

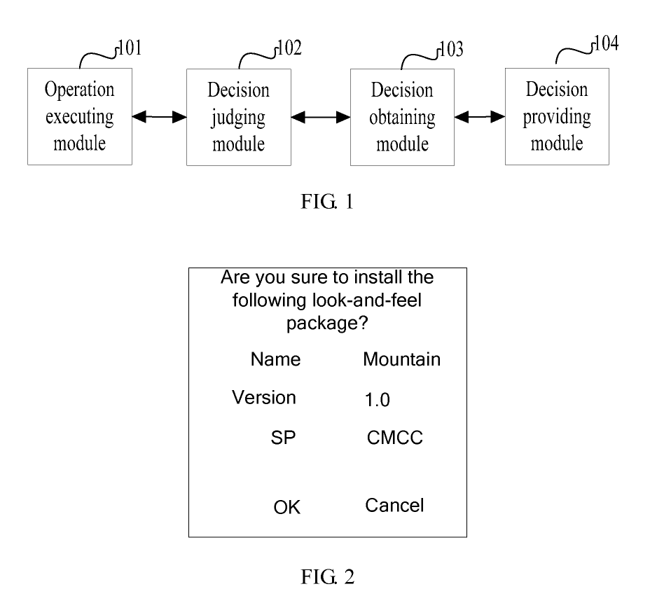

A terminal is provided in the first embodiment of the present invention. As shown in FIG. 1, the terminal includes:

an operation executing module 101, adapted to: send an operation authorization request to a decision judging module 102, receive an operation authorization response from the decision judging module 102, and implement the look-and-feel installation in accordance with the received operation authorization response;

the decision judging module 102, adapted to: send an operation authorization request to a decision obtaining module 103, and judge whether the user agrees to install a look-and-feel package according to the received user authorization information; generate an operation authorization response, and send the operation authorization response to the operation executing module 101;

the decision obtaining module 103, adapted to: obtain user authorization information from a decision providing module 104 according to the received operation authorization request, and send the obtained user authorization information to the decision judging module 102; and

the decision providing module 104, adapted to: provide user authorization information, and send the user authorization information to the decision obtaining module 103.

The relation between the modules of the terminal are detailed below.

Step 101: In the process of installing a look-and-feel package, when the operation executing module needs to seek confirmation from the user, the operation executing module sends an operation authorization request to the decision judging module.

The operation authorization request includes an operation identifier, an installation object, installation time, and size of the installation package. An example of an operation authorization request is given below:

<OperationRequest>

<Category>LFC</Category>
<Command>Install</Command>
<CmdID>15</CmdID>
<Target>

<Name>mountain</Name>
<Version>100</Version>
<Provider>CMCC</Provider>

</Target>
<Time>20070728T000000Z</Time>

</OperationRequest>

where “OperationRequest” indicates an operation request; “Category” indicates the operation type, and the operation type here is a look-and-feel management operation; “Install” indicates that the requested operation is installation; “CmdID” indicates the sequence number of the operation, and identifies the request corresponding to the operation; “Target” indicates the target look-and-feel package of the operation (here the name of the package is “mountain”, and the version is 1.0, which is provided by CMCC); “20070728T000000Z” means that the operation request occurs at 2007-7-28 0:00.

Step 102: The decision judging module sends the received operation authorization request to the decision obtaining module.

Step 103: After receiving the operation authorization request, the decision obtaining module obtains user authorization information from the decision providing module according to the operation authorization request, and sends the obtained user authorization information to the decision judging module.

The decision obtaining module includes a decision obtaining method recording unit, which records four modes of obtaining the user authorization information. The four modes are: querying the Subscriber Identity Module (SIM) to obtain the stored user authorization information, querying the terminal settings to obtain the user authorization information, displaying a dialog box to obtain the user authorization information, and sending a short message to the specified terminal to obtain the user authorization information. According to the extent of difficulty (from low to high) in obtaining the user authorization information, the four methods are arranged below:

1. Querying the terminal settings to obtain user authorization information;

2. Querying the SIM card to obtain the stored user authorization information;

3. Displaying a dialog box to obtain user authorization information; and

4. Sending a short message to the specified terminal to obtain user authorization information.

According to the extent of reliability (from high to low) in obtaining the user authorization information, the four methods are arranged below:

1. Displaying a dialog box to obtain user authorization information;

2. Sending a short message to the specified terminal to obtain user authorization information;

3. Querying the terminal settings to obtain user authorization information; and

4. Querying the SIM card to obtain the stored user authorization information.

The modes of obtaining user authorization information are not limited to the four modes listed above, and the criteria of arranging the modes are not limited to the two criteria given above. The user may also arrange the modes of obtaining user authorization information to determine the priority order.

In this embodiment, the decision obtaining module obtains the user authorization information in the priority order of difficulty (from low to high) in obtaining the user authorization information. The first mode is to query the terminal settings to obtain the user authorization information. The matching results may be queried through the following parameters:

[Category]=LFC

[Command]=Install

[Provider]=CMCC

If no matching result is obtained according to such parameters, “[Result]=NoMatch” is returned to indicate failure of obtaining the user authorization information.

If the decision obtaining module fails to obtain the user authorization information by querying the terminal, the decision obtaining module queries the SIM to obtain the stored user authorization information. In this case, the decision providing module can be in the form of a program that reads the SIM card. The decision obtaining module queries the corresponding file in the SIM card. The file records the decision information of the user. If no corresponding file is found, the user authorization information may be obtained through a pop-up dialog box. In this case, the decision providing module can be in the form of the user interface of the dialog box. FIG. 2 depicts an example of a user interface of the dialog box.

In this embodiment, the user selects “OK”. After receiving the “OK” decision information of the user, the decision obtaining module returns the decision information to the decision judging module.

Step 104: The decision judging module generates user decision information according to the received user authorization information, generates an operation authorization response according to the user decision information, and sends the operation authorization response to the operation executing module.

An example of an operation authorization response is given below:

<Result>

<Command>Install</Command>
<CmdID>15</CmdID>
<Data>200</Data>

</Result>

The program segment above indicates that the user agrees to install the look-and-feel package.

In this embodiment, because the user selects “OK”, the decision judging module determines that the user agrees to install the look-and-feel package.

Step 105: The operation executing module decides whether to execute installation of the look-and-feel package according to the received operation authorization response. If the user agrees, the operation executing module continues to install the look-and-feel package; if the user gives up the installation, the operation executing module aborts.

In this embodiment, because the user agrees to install the package, the look-and-feel installation process goes on.

This embodiment takes the look-and-feel installation as an example, but the look-and-feel management operations are not limited to look-and-feel installation.

The technical solution under the present invention assembles the executing codes and the judging codes into separate modules. When the SP needs to add modes of obtaining user authorization information, the codes do not need to be modified massively, thus making it convenient to maintain and extend codes and improving the stability and extensibility of the product. Moreover, the decision judgment criteria and the judgment results are stored, thus improving the decision speed.

### Embodiment 2

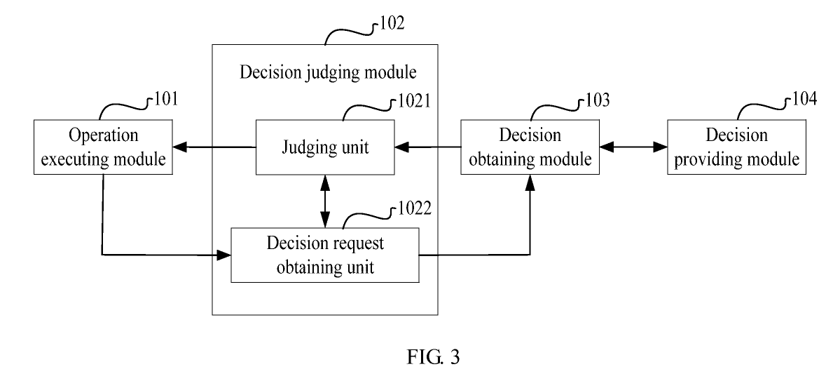

A terminal is provided in this embodiment, as shown in FIG. 3. This embodiment differs from the first embodiment in that: After receiving the operation authorization request, the decision judging module 102 in the terminal judges whether a result matches the operation authorization request. If such a result exists, the decision judging module 102 generates an operation authorization response according to the matching result, and sends the operation authorization response to the operation executing module 101. If no such result exists, the decision judging module 102 sends the operation authorization request to the decision obtaining module 103.

Specifically, the decision judging module 102 includes:

a decision request obtaining unit 1021, adapted to: send the received operation authorization request to a judging unit, and back up the operation authorization request; and send the backup operation authorization request to the decision obtaining module 103 when receiving information indicative of no matching result from the judging unit; and

the judging unit 1022, adapted to: judge whether a result matches the operation authorization request according to the received operation authorization request; if such a result exists, generate an operation authorization response according to the matching result, and send the operation authorization response to the operation executing module 101; if no such result exists, send information indicative of no matching result to the decision request obtaining unit 1021; and further adapted to: generate user decision information according to the received user authorization information, generate an operation authorization response according to the user decision information, and send the operation authorization response to the operation executing module 101.

The decision judging module may further include a decision judgment criteria storing unit, which is adapted to store the decision judgment criteria. The period of storage is rather long. The modes of storing the decision judgment criteria are shown in Table 1.

TABLE 1

| | User Authorization |
|---|---|
| Request Operation | Information |
| Installing look-and-feel package | Agree |
| Deleting look-and-feel package | Reject |

After the decision judging module receives an operation authorization request from the operation executing module, the judging unit judges whether a matching result exists in the decision judgment criteria storing unit. If a matching result exists, the judging unit generates an operation authorization response according to the matching result, and sends the operation authorization response to the operation executing module. If no matching result exists, the judging unit sends information indicative of no matching result to the decision request obtaining unit. In this embodiment, the operation authorization request of the operation executing module is a request for installing the Mountain look-and-feel package. The judging unit finds that it is a confirmation request for installing a look-and-feel package, and matching user authorization information (namely, agreeing to install the look-and-feel package) exists in the decision judgment criteria storing unit. In this case, the judging unit determines that the user agrees to install the look-and-feel package according to the matching user authorization information. The judging unit generates an operation authorization response according to the matching result, and sends the operation authorization response to the operation executing module, without obtaining the user authorization information through the decision obtaining module.

Besides, the decision judgment criteria storing unit may directly store the specific judgment result rather than the decision judgment criteria. The storage period is rather long. The judgment result may be the judgment result preset by the manufacturer before shipment. The specific modes of storing the judgment results are shown in Table 2:

TABLE 2

| Request Operation | Judgment Result |
|---|---|
| Installing Mountain look-and-feel package | Agree |
| Deleting Sport look-and-feel package | Reject |

In the process of installing the Mountain V2 look-and-feel package, when the installation program proceeds to the step of seeking confirmation from the user, the judging unit judges whether a matching result exists in the decision judgment criteria storing unit. If a matching result exists, the judging unit generates an operation authorization response according to the matching result, and sends the operation authorization response to the operation executing module. If no matching result exists, the judging unit sends information indicative of no matching result to the decision request obtaining unit. In this embodiment, the judging unit finds a matching result; that is, the user agrees to install the Mountain look-and-feel package. Therefore, the judging unit generates an operation authorization response according to the matching result, and sends the operation authorization response to the operation executing module. The operation executing module decides whether to continue the operation according to the operation authorization response, without asking the user for confirmation. In this way, the judgment steps are shortened, and the process is simplified.

The remaining steps are similar to those of the first embodiment, and are not described further.

The technical solution under the present invention assembles the executing codes and the judging codes into separate modules. When the SP needs to add modes of obtaining user authorization information, the codes do not need to be modified massively, thus making it convenient to maintain and extend codes and improving the stability and extensibility of the product. Moreover, the decision judgment criteria and the judgment results are stored, thus improving the decision speed.

### Embodiment 3

This embodiment differs from the second embodiment in that: The decision request obtaining unit in the decision judging module does not send the received operation authorization request to the judging unit, but sends it to the decision obtaining module directly. The remaining steps are similar to those of the second embodiment, and are not described further.

The technical solution under the present invention assembles the executing codes and the judging codes into separate modules. When the SP needs to add modes of obtaining user authorization information, the codes do not need to be modified massively, thus making it convenient to maintain and extend codes and improving the stability and extensibility of the product. Moreover, the decision judgment criteria and the judgment results are stored, thus improving the decision speed.

### Embodiment 4

In the first embodiment, the decision obtaining method recording unit is in the decision obtaining module, and therefore, the decision obtaining module decides the mode of obtaining the user authorization information. In the fourth embodiment, the decision obtaining method recording unit is in the decision judging module, and therefore, the decision judging module decides the mode of obtaining the user authorization information. For example, four modes of obtaining the user authorization information exist: querying the SIM to obtain the stored user authorization information, querying the terminal settings to obtain the user authorization information, and displaying a dialog box to obtain the user authorization information, and sending a short message to the specified terminal to obtain the user authorization information. The four methods may be arranged in the order of difficulty (from low to high) in obtaining the user authorization information, or arranged in the order of reliability (from high to low) in obtaining the user authorization information. The user may also set the order of arranging the four methods.

In the fourth embodiment, after receiving the operation authorization request, the decision judging module checks the extent of difficulty (from low to high) in obtaining the user authorization information, and decides to select the mode of querying the terminal settings for obtaining the user authorization information. In this case, the decision judging module sends the following information to the decision obtaining module:

[Category]=LFC

[Command]=Install

[Provider]=CMCC

This embodiment differs from the first embodiment in that: The decision judging module does not need to send all of the contents in the operation authorization request to the decision obtaining module, but sends only the part related to the obtaining of the user authorization information, namely, sends only the operation type, operation content, and operation initiator information.

After obtaining the foregoing information, the decision obtaining module obtains the relevant user authorization information from the terminal settings. The remaining steps are similar to those of the first embodiment, and are not described further.

The technical solution under the present invention assembles the executing codes and the judging codes into separate modules. When the SP needs to add modes of obtaining user authorization information, the codes do not need to be modified massively, thus making it convenient to maintain and extend codes and improving the stability and extensibility of the product. Moreover, the decision judgment criteria and the judgment results are stored, thus improving the decision speed.

### Embodiment 5

An operation confirmation method is provided in this embodiment. The method includes:

generating user decision information according to user authorization information when an operation process comes to the step of seeking confirmation from the user; and

generating an operation authorization response according to the user decision information.

Preferably, the method further includes:

deciding whether to continue the operation according to the operation authorization response.

The technical solution under the present invention assembles the executing codes and the judging codes into separate modules. When the SP needs to add modes of obtaining user authorization information, the codes do not need to be modified massively, thus making it convenient to maintain and extend codes and improving the stability and extensibility of the product.

The technical solution under the present invention is applicable to not only the scenario of look-and-feel management, but also the scenario of seeking confirmation from the user in the process of downloading a Multimedia Message Service (MMS) message and other scenarios that require confirmation from the user.

Although the present invention has been described through some exemplary embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

What is claimed is:

1. A terminal, comprising:
an operation executing module, adapted to send an operation authorization request; and
a decision judging module, adapted to receive the operation authorization request, obtain user authorization information according to the operation authorization request; and send an operation authorization response to the operation executing module in response to the operation authorization request according to the user authorization information.

2. The terminal of claim 1, wherein the operation executing module is adapted to decide whether to continue according to the received operation authorization response.

3. The terminal of claim 1, further comprising:
a decision obtaining module, adapted to obtain the user authorization information, and send the user authorization information to the decision judging module.

4. The terminal of claim 3, wherein the decision judging module comprises:
a first judging unit, adapted to receive the user authorization information from the decision obtaining module, generate the operation authorization response according to the user authorization information, and send the operation authorization response to the operation executing module.

5. The terminal of claim 3, wherein the decision judging module comprises:
a first decision request obtaining unit, adapted to receive the operation authorization request, back up the operation authorization request, and send the operation authorization request to a second judging unit, and send the backup operation authorization request to the decision obtaining module when receiving information indicative of no matching result from the second judging unit; and
the second judging unit, adapted to: receive the operation authorization request, judge whether a judgment result matches the operation authorization request, and send the information indicative of no matching result to the first decision request obtaining unit if no matching result exists, receive the user authorization information from the decision obtaining module, generate the operation authorization response according to the user authorization information, and send the operation authorization response to the operation executing module.

6. The terminal of claim 5, wherein the decision judging module further comprises:
a decision judgment criteria storing unit, adapted to store decision judgment criteria, wherein:
the decision judgment criteria are used for the second judging unit to judge whether any result matches the operation authorization request, and if any matching result exists, the second judging unit generates the operation authorization response according to the matching result, and sends the operation authorization response to the operation executing module.

7. The terminal of claim 1, wherein:
the decision judging module obtains the user authorization information according to a stored priority of obtaining the user authorization information; or, the decision obtaining module obtains the user authorization information according to the stored priority of obtaining the user authorization information, and sends the user authorization information to the decision judging module.

8. An operation confirmation method, comprising:
receiving, by a decision judging module, an operation authorization request from an operation executing module; and
obtaining, by the decision judging module, user authorization information according to the operation authorization request, and sending an operation authorization response to the operation executing module in response to the operation authorization request according to the user authorization information.

9. The operation confirmation method of claim 8, further comprising:
deciding, by the operation executing module, whether to continue according to the received operation authorization response.

10. The operation confirmation method of claim 8, wherein:
the process of sending the operation authorization response to the operation executing module in response to the operation authorization request according to the user authorization information comprises:
sending, by the decision judging module, the received operation authorization request to a decision obtaining module;
obtaining, by the decision obtaining module, the user authorization information according to the operation authorization request, and sending the user authorization information to the decision judging module; and
generating, by the decision judging module, the operation authorization response according to the user authorization information, and sending the operation authorization response to the operation executing module.

11. The operation confirmation method of claim 8, wherein:
the process of sending the operation authorization response to the operation executing module in response to the operation authorization request according to the user authorization information comprises:
sending, by a decision request obtaining unit, the received operation authorization request to a judging unit, and backing up the operation authorization request; and
judging, by the judging unit, whether any result matches the operation authorization request, and (a) if any matching result exists, generating the operation authorization response according to the matching result, and sending the operation authorization response to the operation executing module, and (b) if no matching result exists, sending information indicative of no matching result to the decision request obtaining unit; and
receiving, by the decision request obtaining unit, the information indicative of no matching result, and sending the backup operation authorization request to a decision obtaining module.

12. The operation confirmation method of claim 8, wherein:
the process of obtaining the user authorization information according to the operation authorization request comprises:
obtaining the user authorization information according to a priority of obtaining the user authorization information.
